(19) United States
(12) Patent Application Publication
(10) Pub. No.: US 2025/0241500 A1
(43) Pub. Date: Jul. 31, 2025

(54) FLOOR SCRUBBER

(71) Applicant: JIAXING JACKSON TRAVEL PRODUCTS CO., LTD., Jiaxing (CN)

(72) Inventors: Tao JIANG, Jiaxing (CN); Hao CHEN, Jiaxing (CN); Hongwei LIU, Jiaxing (CN); Xuman DENG, Jiaxing (CN)

(73) Assignee: JIAXING JACKSON TRAVEL PRODUCTS CO., LTD., Jiaxing (CN)

(21) Appl. No.: 18/659,041

(22) Filed: May 9, 2024

(30) Foreign Application Priority Data
Jan. 29, 2024 (CN) 2024202033780

(51) Int. Cl. A47L 11/40; A46B 9/00; A46B 13/00; A46B 13/04; A47L 11/292; B08B 1/16; B08B 1/20

(52) U.S. Cl. CPC A47L 11/4016; A46B 9/005; A46B 13/001; A46B 13/04; A47L 11/292; A47L 11/4025; A47L 11/4027; A47L 11/4041; A47L 11/4069; A47L 11/4083; A47L 11/4088; B08B 1/165; B08B 1/20; A46B 2200/3033

(57) ABSTRACT

A floor scrubber is provided. The floor scrubber includes a machine body and a machine base. A roller brush for rotatably cleaning a ground is arranged on the machine base, and a garbage collection box is arranged in the machine base. The roller brush can carry ground garbage into the garbage collection box, and the machine base is further provided with a sewage collection chamber. A water squeezing device that can squeeze sewage on the roller brush into the sewage collection chamber is arranged on the machine base. The garbage collection box is arranged in the machine base to collect the garbage, the water squeezing device is arranged to squeeze out the sewage on the roller brush, and the sewage is collected by the sewage collection chamber, thus achieving classified collection of the garbage and the sewage.

### CROSS-REFERENCE TO THE RELATED APPLICATIONS

This application is based upon and claims priority to Chinese Patent Application No. 202420203378.0, filed on Jan. 29, 2024, the entire contents of which are incorporated herein by reference.

### TECHNICAL FIELD

The present disclosure relates to the technical field of cleaning appliances, and in particular, to a floor scrubber.

### BACKGROUND

Floor scrubbers, as household appliances for cleaning, are increasingly favored by a large number of users. With the development of floor scrubber products, users are increasingly concerned about cleaning efficiency of floor scrubber products.

The floor scrubber in the prior art often collects garbage and sewage into a same collection chamber during use, but it is difficult to perform cleaning after mixing of the garbage and the sewage in the collection chamber, thereby affecting user experience.

### SUMMARY

Against the above problems existing in the prior art, an objective of the present disclosure is to provide a floor scrubber that can implement classified collection of garbage and sewage.

The objective of the present disclosure can be achieved by the following technical solutions: A floor scrubber includes a machine body and a machine base, where a roller brush for rotatably cleaning a ground is arranged on the machine base, a garbage collection box is arranged in the machine base, the roller brush can carry ground garbage into the garbage collection box when rotating, the machine base is further provided with a sewage collection chamber, and a water squeezing device that can squeeze sewage on the roller brush into the sewage collection chamber is arranged on the machine base.

The roller brush is configured to clean the ground. The garbage collection box is arranged in the machine base to collect the garbage, the water squeezing device is arranged to squeeze out the sewage on the roller brush, and the sewage is collected by the sewage collection chamber, thus achieving classified collection of the garbage and the sewage.

In the above-mentioned floor scrubber, a side of the machine base close to the roller brush is provided with an opening, and a first scraping strip that can scrape garbage adhering to the roller brush into the garbage collection box from the opening is arranged between the machine base and the roller brush.

The opening is provided for the garbage to enter, and the first scraping strip can scrape the garbage into the garbage collection box when the roller brush rotates.

In the above-mentioned floor scrubber, as another solution, a side of the machine base close to the roller brush is provided with an opening, and a second scraping strip that can scrape garbage adhering to the roller brush into the garbage collection box from the opening is further arranged on the machine base.

The opening is provided for the garbage to enter, and the second scraping strip can also scrape the garbage on the roller brush into the garbage collection box.

In the above-mentioned floor scrubber, the water squeezing device is a squeezing block arranged on the machine base, and can squeeze the sewage on the roller brush into the sewage collection chamber when the roller brush rotates. The squeezing block is arranged to squeeze the roller brush in a rotating state, so that the sewage is squeezed into the sewage collection chamber.

In the above-mentioned floor scrubber, the roller brush includes an inner cylinder and a flexible layer positioned on an outer side of the inner cylinder and fixedly connected to the inner cylinder, and the flexible layer is made of a polyvinyl alcohol (PVA) or polyvinyl butyral resin (PVB) material.

In the above-mentioned floor scrubber, a driving device that can drive the roller brush to rotate is arranged in the machine body or the machine base. The driving device is arranged, so that a user can save more labor, and cleaning efficiency can be improved with no need to manually drag the roller brush.

In the above-mentioned floor scrubber, the driving device includes a motor arranged in the machine body or the machine base and a driving wheel arranged on an output shaft of the motor, an end of the roller brush is provided with a driven wheel rotating coaxially with the roller brush, and a transmission belt is arranged between the driving wheel and the driven wheel.

The motor drives the driving wheel to rotate, and the driving wheel rotates to drive the transmission belt to move. The transmission belt moves to drive the driven wheel to move, and the driven wheel moves to drive the coaxial roller brush to rotate synchronously.

In the above-mentioned floor scrubber, the machine base is provided with a clean water pipeline that can spray clean water to the roller brush, a clean water tank is arranged on the machine body or the machine base, and the clean water tank is connected to the clean water pipeline; and a clean water pump that can pump clean water in the clean water tank to the clean water pipeline and spray the clean water is arranged between the clean water tank and the clean water pipeline.

The clean water in the clean water tank is conveyed into the roller brush through the clean water pipeline, the clean water permeates to the roller brush to wet the roller brush, so that the wet roller brush facilitates cleaning of the ground, and the garbage on the ground is more easily sucked to the roller brush. The clean water pump accelerates conveying of the clean water, which can also prevent the clean water pipeline from being accidentally blocked.

In the above-mentioned floor scrubber, a sewage tank is arranged on the machine body or the machine base, a sewage pipeline is further arranged between the sewage tank and the sewage collection chamber, and a sewage pump that can pump sewage to the sewage tank is arranged between the sewage tank and the sewage collection chamber.

The sewage in the sewage collection chamber is conveyed to the sewage tank through the sewage pipeline, and the sewage pump can accelerate conveying of the sewage, which can also prevent the sewage pipeline from being blocked accidentally.

In the above-mentioned floor scrubber, as another solution, a sewage tank and a clean water tank are arranged on the machine body or the machine base, the clean water tank communicates with the roller brush through a clean water pipeline, the sewage tank communicates with the sewage collection chamber through a sewage pipeline, and a filtering device that can filter the sewage is arranged between the sewage tank and the clean water tank.

The clean water in the clean water tank may be conveyed into the roller brush through the clean water pipeline, and the sewage in the sewage collection chamber may be conveyed into the sewage tank through the sewage pipeline to be collected. The filtering device may be a filter screen, and the filter screen may be provided with filter holes to filter the sewage in the sewage tank, thereby achieving recycling and reducing water consumption.

In the above-mentioned floor scrubber, a flip cover for blocking the roller brush is further arranged on the machine base and located above the roller brush. The flip cover is arranged above the roller brush to prevent the sewage from splashing upward and can prevent dust from falling into the roller brush.

In the above-mentioned floor scrubber, the machine base is further provided with a dumping port for a user to dump out garbage in the garbage collection box. The dumping port is provided to facilitate cleaning out of accumulated garbage in the garbage collection box by the user.

In the above-mentioned floor scrubber, the driving device includes a motor arranged in the machine body or the machine base, the motor drives and is connected to a first transmission member and a second transmission member rotatably connected to the first transmission member, and an axial direction of a rotating shaft that rotatably connects the first transmission member to the second transmission member is perpendicular to an axial direction of the second transmission member;

the roller brush includes an inner cylinder and a flexible layer positioned on an outer side of the inner cylinder and fixedly connected to the inner cylinder; the inner cylinder has a cavity that can be sleeved outside the first transmission member and the second transmission member, and an end of the cavity has an open port for the second transmission member to enter or exit; when the inner cylinder is sleeved on the first transmission member and the second transmission member, the first transmission member and the second transmission member are coaxial, and the movement of the inner cylinder and the first transmission member or the second transmission member in a circumferential direction is restricted; and when the inner cylinder is detached from the second transmission member or mounted on the second transmission member, the second transmission member rotates away from the machine base, and the first transmission member has a length less than that of the second transmission member.

The open port is positioned at one end of the inner cylinder, the other end of the inner cylinder is provided with a shaft member, the shaft member is movably connected to the inner cylinder in an axial direction of the inner cylinder, an elastic member is arranged between the shaft member and the inner cylinder, and the elastic member applies a force to the shaft member to make the shaft member tend to move toward an outer end; the shaft member is rotatably connected to a mounting base, and the machine base is provided with a hole position for arranging the mounting base; after the elastic member is compressed, the mounting base can be separated from the hole position, and the roller brush can be detached; and after the elastic member rebounds, the shaft member abuts against the mounting base to be arranged at the hole position.

Both the hole position and the mounting base are non-circular, and when the mounting base is arranged at the hole position, the movement of the mounting base and the hole position in a circumferential direction is restricted.

Compared with the prior art, according to the present disclosure, the garbage collection box is arranged in the machine base to collect the garbage, the water squeezing device is arranged to squeeze out the sewage on the roller brush, and the sewage is collected by the sewage collection chamber, thus achieving classified collection of the garbage and the sewage. The side of the machine base is provided with the opening for the garbage to enter, and the first scraping strip can scrape the garbage into the garbage collection box when the roller brush rotates. The second scraping strip is arranged to reduce garbage residue on the roller brush. The squeezing block is arranged to squeeze the roller brush in a rotating state, so that the sewage is squeezed into the sewage collection chamber. The driving device is arranged, so that the user can save more labor, and cleaning efficiency can be improved with no need to manually drag the roller brush. The clean water in the clean water tank is conveyed into the roller brush through the clean water pipeline, and the clean water pump accelerates conveying of the clean water, which can also prevent the clean water pipeline from being accidentally blocked. The sewage in the sewage collection chamber is conveyed to the sewage tank through the sewage pipeline, and the sewage pump can accelerate conveying of the sewage, which can also prevent the sewage pipeline from being blocked accidentally. The filtering device that can filter the sewage is arranged between the sewage tank and the clean water tank, so that cycling use of water can be achieved.

### BRIEF DESCRIPTION OF THE DRAWINGS

FIG. 1 is a schematic three-dimensional structural diagram of the present disclosure;

FIG. 2 is a sectional view of the present disclosure.

FIG. 3 is a first schematic diagram of the present disclosure with a partial structure hidden;

FIG. 4 is a second schematic diagram of the present disclosure with a partial structure hidden;

FIG. 5 is a schematic diagram of a mounting structure of a machine base and a roller brush according to the present disclosure;

FIG. 6 is a schematic structural diagram of the roller brush according to the present disclosure;

FIG. 7 is a schematic diagram of a structure of FIG. 6 from another perspective; and

FIG. 8 is a schematic structural diagram of the roller brush according to the present disclosure from another perspective.

### DETAILED DESCRIPTION OF THE EMBODIMENTS

The following are specific embodiments of the present disclosure, and further describe technical solutions of the present disclosure in conjunction with accompanying drawings, but the present disclosure is not limited to these embodiments.

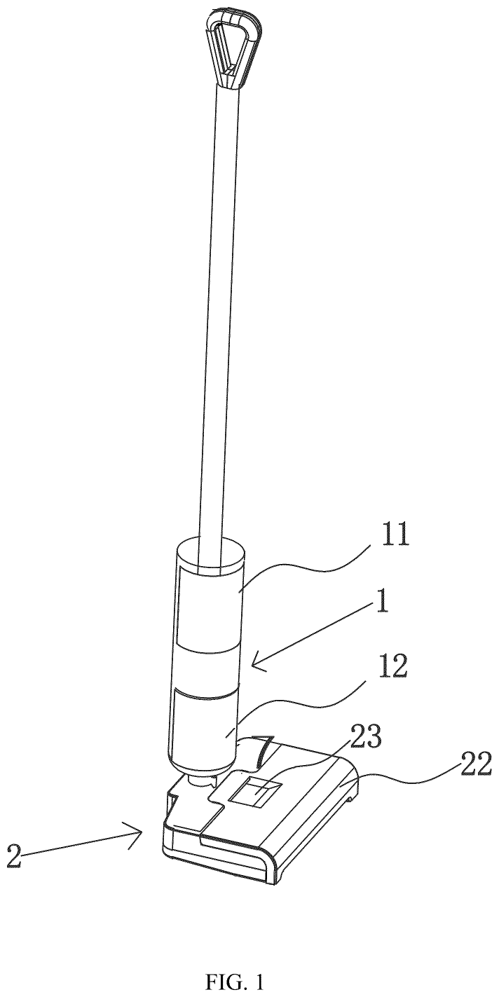

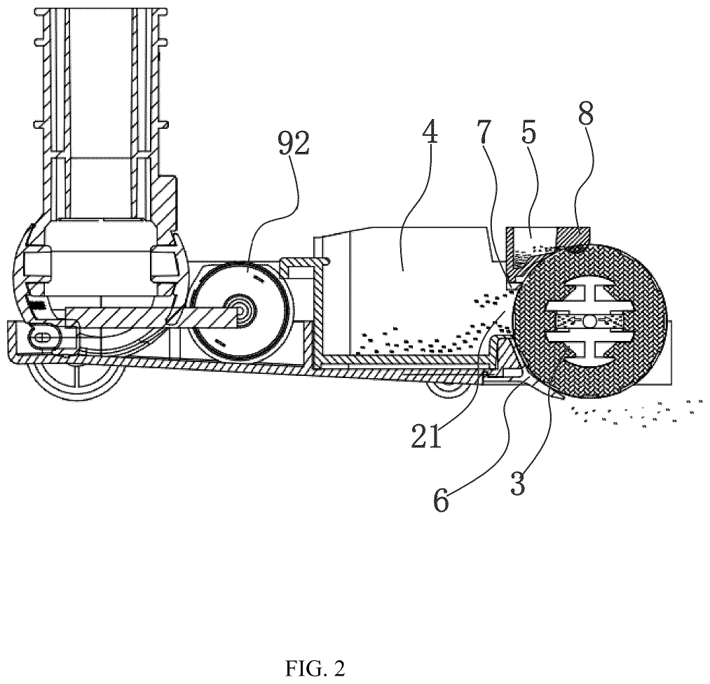

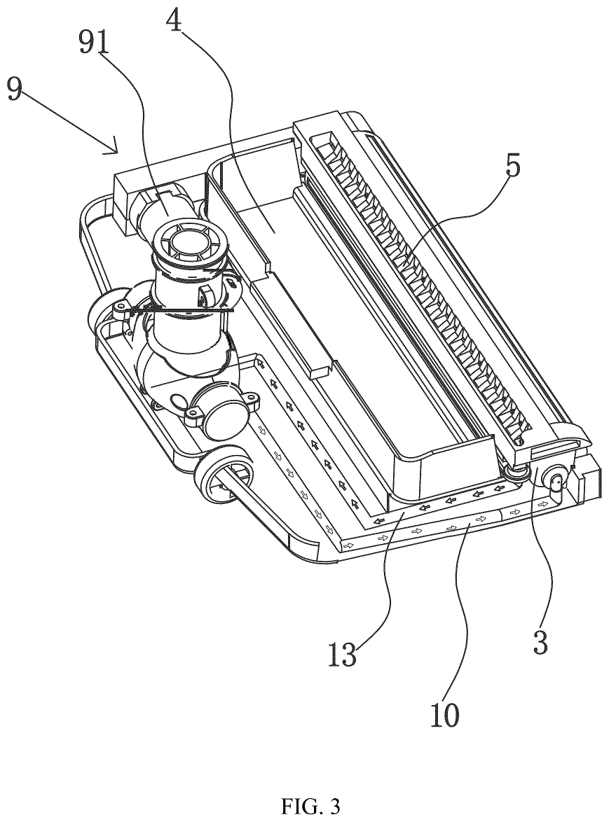

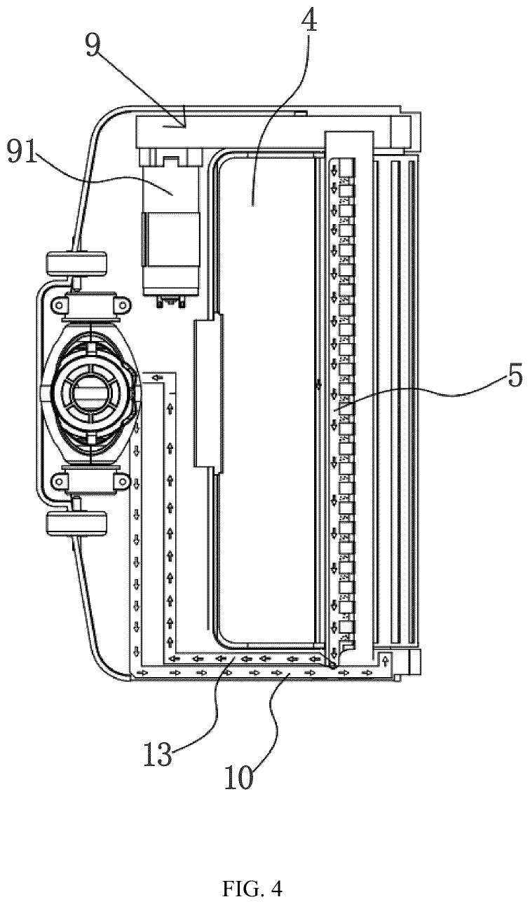

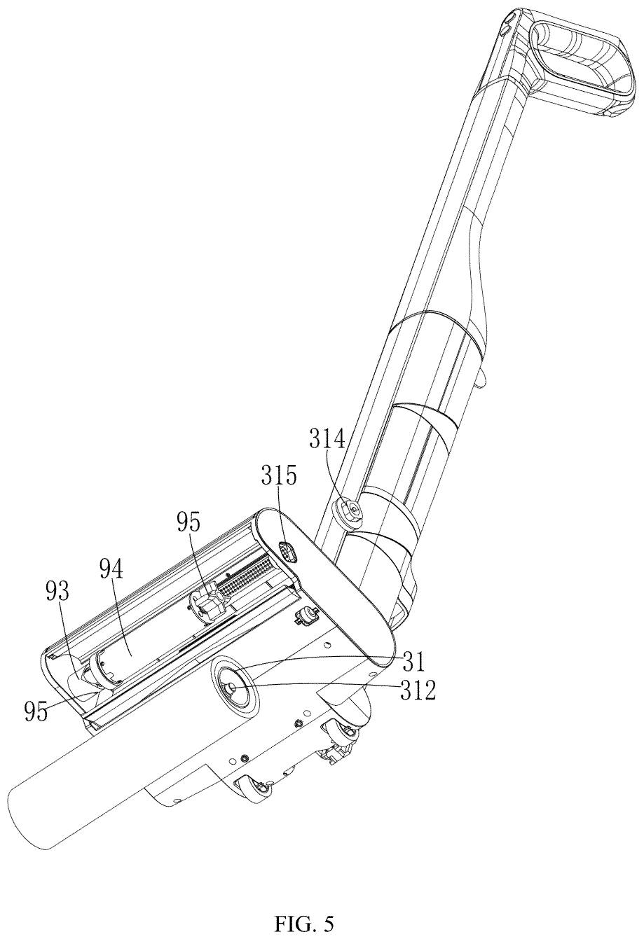

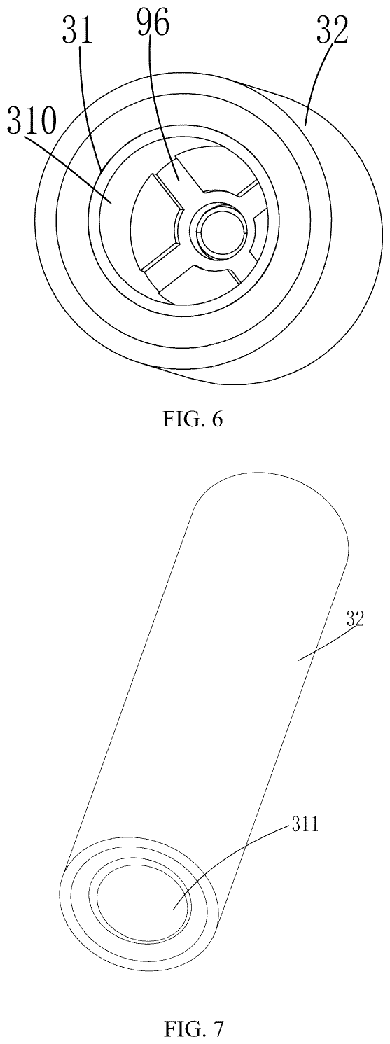

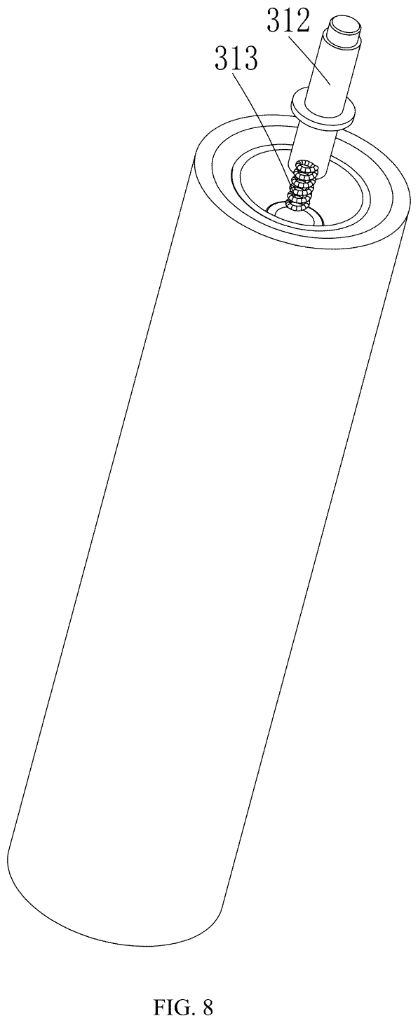

As shown in FIGS. 1-8, a floor scrubber according to the present disclosure includes a machine body 1 and a machine base 2. A roller brush 3 for rotatably cleaning a ground is arranged on the machine base 2, and a garbage collection box 4 is arranged in the machine base 2. The roller brush 3 can carry ground garbage into the garbage collection box 4. The machine base 2 is further provided with a sewage collection chamber 5, and a water squeezing device that can squeeze sewage on the roller brush 3 into the sewage collection chamber 5 is arranged on the machine base 2.

The roller brush 3 is configured to clean the ground. The garbage collection box 4 is arranged in the machine base 2 to collect the garbage, the water squeezing device is arranged to squeeze out the sewage on the roller brush 3, and the sewage is collected by the sewage collection chamber 5, thus achieving classified collection of the garbage and the sewage.

A side of the machine base 2 close to the roller brush 3 is provided with an opening 21, and a first scraping strip 6 that can scrape garbage adhering to the roller brush 3 into the garbage collection box 4 from the opening 21 is arranged between the machine base 2 and the roller brush 3. The opening 21 is provided for the garbage to enter, and the first scraping strip 6 can scrape the garbage into the garbage collection box 4 when the roller brush 3 rotates. A second scraping strip 7 that can scrape garbage adhering to the roller brush 3 into the garbage collection box 4 from the opening 21 is further arranged on the machine base 2. The second scraping strip 7 can also scrape the garbage on the roller brush 3 into the garbage collection box 4.

The water squeezing device is a squeezing block 8 arranged on the machine base 2, and can squeeze the sewage on the roller brush 3 into the sewage collection chamber 5 when the roller brush 3 rotates. The squeezing block 8 is arranged to squeeze the roller brush 3 in a rotating state, so that the sewage is squeezed into the sewage collection chamber 5.

A driving device 9 that can drive the roller brush 3 to rotate is arranged in the machine base 2. The driving device 9 includes a motor 91 arranged in the machine base 2 and a driving wheel 92 arranged on an output shaft of the motor 91. An end of the roller brush 3 is provided with a driven wheel (not shown) rotating coaxially with the roller brush 3, and a transmission belt (not shown) is arranged between the driving wheel 92 and the driven wheel. The motor 91 drives the driving wheel 92 to rotate, and the driving wheel 92 rotates to drive the transmission belt to move. The transmission belt moves to drive the driven wheel to move, and the driven wheel moves to drive the coaxial roller brush 3 to rotate synchronously.

The roller brush 3 is internally provided with a clean water pipeline 10, and clean water in the clean water pipeline 10 can penetrate to the roller brush 3. A clean water tank 11 is arranged on the machine body 1, and the clean water tank 11 is connected to the clean water pipeline 10. A clean water pump (not shown) that can pump clean water in the clean water tank 11 to the clean water pipeline 10 is arranged between the clean water tank 11 and the clean water pipeline 10. The clean water in the clean water tank 11 is conveyed into the roller brush 3 through the clean water pipeline 10, the clean water permeates to the roller brush 3 to wet the roller brush 3, so that the wet roller brush 3 facilitates cleaning of the ground, and the garbage on the ground is more easily sucked to the roller brush 3. The clean water pump accelerates conveying of the clean water, which can also prevent the clean water pipeline 10 from being accidentally blocked.

A sewage tank 12 is arranged on the machine body 1, and a sewage pipeline 13 is further arranged between the sewage tank 12 and the sewage collection chamber 5. A sewage pump (not shown) that can pump sewage in the sewage pipeline 13 to the sewage tank 12 is arranged between the sewage tank 12 and the sewage pipeline 13. The sewage in the sewage collection chamber 5 is conveyed to the sewage tank 12 through the sewage pipeline 13, and the sewage pump can accelerate conveying of the sewage, which can also prevent the sewage pipeline 13 from being blocked accidentally.

A filtering device (not shown) that can filter the sewage is further arranged between the sewage tank 12 and the clean water tank 11. The filtering device is a filter screen, and the filter screen may be provided with filter holes to filter the sewage in the sewage tank 12, thereby achieving recycling and reducing water consumption.

A flip cover 22 for blocking the roller brush 3 is further arranged on the machine base 2 and located above the roller brush 3, and the machine base 2 is further provided with a dumping port 23 for a user to dump out garbage in the garbage collection box 4. The flip cover 22 is arranged above the roller brush 3 to prevent the sewage from splashing upward and can prevent dust from falling into the roller brush 3. The dumping port 23 is provided to facilitate cleaning out of accumulated garbage in the garbage collection box 4 by the user.

The working principle of that the present disclosure is as follows. The clean water pump conveys clean water in the clean water tank 11 to the clean water pipeline 10, and the clean water is conveyed into the roller brush 3 through the clean water pipeline 10. The clean water in the roller brush 3 gradually permeates to the outside to wet the roller brush 3. The motor 91 rotates to drive the driving wheel 92 on the output shaft of the motor to rotate, and the driving wheel 92 rotates to drive the transmission belt thereon to move. The transmission belt moves to drive the driven wheel to rotate, and the driven wheel rotates to drive the roller brush 3 coaxial therewith to rotate. The roller brush 3 rotates to cause garbage or stains on the ground to adhere to its surface. The first scraping strip 6 and the second scraping strip 7 on the machine base 2 scrape the garbage on the roller brush 3 into the garbage collection box 4 from the opening 21. The squeezing block 8 above the roller brush 3 squeezes the roller brush 3 to squeeze the sewage into the sewage collection chamber 5, and the sewage in the sewage collection chamber 5 flows to a sewage pipeline. The sewage pump pumps the water in the sewage pipeline to the sewage tank 12, and the sewage in the sewage tank 12 can be filtered to the clean water tank 11 by the filtering device. The garbage in the garbage collection box 4 can be dumped by the user to be discharged from the dumping port 23.

According to the present disclosure, the garbage collection box 4 is arranged in the machine base 2 to collect the garbage, the water squeezing device is arranged to squeeze out the sewage on the roller brush 3, and the sewage is collected by the sewage collection chamber 5, thus achieving classified collection of the garbage and the sewage. The side of the machine base 2 is provided with the opening 21 for the garbage to enter, and the first scraping strip 6 can scrape the garbage into the garbage collection box 4 when the roller brush 3 rotates. The second scraping strip 7 is arranged to reduce garbage residue on the roller brush 3. The squeezing block 8 is arranged to squeeze the roller brush 3 in a rotating state, so that the sewage is squeezed into the sewage collection chamber 5. The driving device 9 is arranged, so that the user can save more labor, and cleaning efficiency can be improved with no need to manually drag the roller brush 3. The clean water in the clean water tank 11 is conveyed into the roller brush 3 through the clean water pipeline 10, and the clean water pump accelerates conveying of the clean water, which can also prevent the clean water pipeline 10 from being accidentally blocked. The sewage in the sewage collection chamber 5 is conveyed to the sewage tank 12 through the sewage pipeline 13, and the sewage pump can accelerate conveying of the sewage, which can also prevent the sewage pipeline 13 from being blocked accidentally. The filtering device that can filter sewage is arranged between the sewage tank 12 and the clean water tank 11, so that cycling use of water can be achieved.

The driving device 9 includes a motor 91 arranged in the machine body 1 or the machine base 2. The motor 91 drives and is connected to a first transmission member 93 and a second transmission member 94 rotatably connected to the first transmission member 93, and an axial direction of a rotating shaft 95 that rotatably connects the first transmission member 93 to the second transmission member 94 is perpendicular to an axial direction of the second transmission member 94.

The roller brush 3 includes an inner cylinder 31 and a flexible layer 32 positioned on an outer side of the inner cylinder 31 and fixedly connected to the inner cylinder 31. The inner cylinder 31 has a cavity 310 that can be sleeved outside the first transmission member 93 and the second transmission member 94, and an end of the cavity 310 has an open port 311 for the second transmission member 94 to enter or exit. When the inner cylinder 31 is sleeved on the first transmission member 93 and the second transmission member 94, the first transmission member 93 and the second transmission member 94 are coaxial, and the movement of the inner cylinder 31 and the first transmission member 93 or the second transmission member 94 in a circumferential direction is restricted. In this embodiment, an end of the second transmission member 94 away from the first transmission member 93 is provided with a male connector 95 with a cross-shaped cross section, and the inner cylinder 31 is provided with a cross-shaped female connector 96 that is in concave-convex matching with the cross-shaped male connector. The male connector and the female connector cannot move freely in a circumferential direction after being in concave-convex matching with each other, so that the second transmission member 94 is fixed to the inner cylinder 31 in the circumferential direction, and the rotation of the second transmission member 94 can drive the inner cylinder 31 to rotate. The male connector 95 and the female connector 96 may be in multiple shapes, such as a triangle, a quadrilateral, a pentagon, and a hexagon, provided that the male connector and the female connector each are of a non-circular structure and can achieve transmission of a torque when rotating in the circumferential direction. In this implementation, when the roller brush 3 is mounted on the first transmission member 93 and the second transmission member 94, the inner cylinder 31 sleeved on peripheries of the first transmission member 93 and the second transmission member 94 restricts the rotation between the first transmission member 93 and the second transmission member 94, and there is no loss in torque transmission between the first transmission member 93 and the second transmission member 94. Moreover, the inner cylinder 31 itself is rigid, and sleeves the first transmission member 93 and the second transmission member 94, so that the rotation between the first transmission member 93 and the second transmission member 94 does not adversely affect a stress on the roller brush 3 after landing.

When the inner cylinder 31 is detached from the second transmission member 94 or mounted on the second transmission member 94, the second transmission member 94 rotates away from the machine base 2. When the roller brush 3 needs to be detached, since the first transmission member 93 has a length obviously less than that of the second transmission member 94, and the roller brush 3 has a gap in an axial direction, after the roller brush 3 moves away from the first transmission member 93, an influence of the inner cylinder 31 on rotating joints of the first transmission member 93 and the second transmission member 94 is eliminated, and the roller brush 3 can be removed after the second transmission member 94 rotates, thereby conveniently achieving detachment and mounting. The inner cylinder 31, the first transmission member 93, and the second transmission member 94 have a long overlap, thereby achieving a more sufficient supporting force after landing and more stable operation.

In a preferred implementation, the open port 311 is positioned at one end of the inner cylinder 31, and the other end of the inner cylinder 31 is provided with a shaft member 312. The shaft member 312 is kept in the inner cylinder 31, and the shaft member 312 is movably connected to the inner cylinder 31 in an axial direction of the inner cylinder 31. An elastic member 313 is arranged between the shaft member 312 and the inner cylinder 31, and the elastic member 313 applies a force to the shaft member 312 to make the shaft member tend to move toward an outer end. The elastic member 313 is a spring, and the spring is connected to the shaft member 312 and the inner cylinder 31. The shaft member 312 is rotatably connected to a mounting base 314, and the machine base 2 is provided with a hole position 315 for arranging the mounting base 314. After the elastic member 313 is compressed, the mounting base 314 can be separated from the hole position 315, and the roller brush 3 can be detached. After the elastic member 313 rebounds, the shaft member 312 abuts against the mounting base 314 to be arranged at the hole position 315. In a preferred implementation, both the hole position 315 and the mounting base 314 are non-circular, and when the mounting base 314 is arranged at the hole position 315, the movement of the mounting base 314 and the hole position 315 in a circumferential direction is restricted. In this embodiment, one end of the roller brush 3 is supported by the first transmission member 93 or the second transmission member 94, the other end of the roller brush 3 is connected to the machine base 2 by means of the mounting base 314, the shaft member 312 is rotatably connected to the mounting base 314, and the movement of the mounting base 314 and the machine base 2 in a circumferential direction is fixed. The mounting base 314 can be kept connected to the machine base 2 after being subjected to an elastic force of the shaft member 312, and after the elastic force is overcome, the mounting base 314 can also be detached from the hole position 315. According to the mounting structure, the roller brush 3 can be quickly and stably replaced and cleaned.

The specific embodiments described herein merely illustrate the spirit of the present disclosure. A person skilled in the technical field to which the present disclosure belongs may make various modifications or supplements on the described specific embodiments or substitute them in a similar way, without departing from the spirit of the present disclosure or exceeding the scope defined by the appended claims.

What is claimed is:

1. A floor scrubber, comprising a machine body and a machine base, wherein a roller brush for rotatably cleaning a ground is arranged on the machine base, a garbage collection box is arranged in the machine base, the roller brush is allowed for carrying ground garbage into the garbage collection box when rotating, the machine base is further provided with a sewage collection chamber, and a water squeezing device is arranged on the machine base, wherein the water squeezing device is allowed for squeezing sewage on the roller brush into the sewage collection chamber.

2. The floor scrubber according to claim 1, wherein a side, adjacent to the roller brush, of the machine base is provided with an opening, and a first scraping strip is arranged between the machine base and the roller brush, wherein the first scraping strip is allowed for scraping garbage adhering to the roller brush into the garbage collection box from the opening.

3. The floor scrubber according to claim 1, wherein a side, adjacent to the roller brush, of the machine base is provided with an opening, and a second scraping strip is further arranged on the machine base, wherein the second scraping strip is allowed for scraping garbage adhering to the roller brush into the garbage collection box from the opening.

4. The floor scrubber according to claim 1, wherein the water squeezing device is a squeezing block arranged on the machine base, and when the roller brush rotates, the squeezing block is allowed for squeezing the sewage on the roller brush into the sewage collection chamber.

5. The floor scrubber according to claim 1, wherein the roller brush comprises an inner cylinder and a flexible layer positioned on an outer side of the inner cylinder and fixedly connected to the inner cylinder, and the flexible layer is made of a polyvinyl alcohol (PVA) or polyvinyl butyral resin (PVB) material.

6. The floor scrubber according to claim 1, wherein a driving device is arranged in the machine body or the machine base, wherein the driving device is allowed for driving the roller brush to rotate.

7. The floor scrubber according to claim 6, wherein the driving device comprises a motor arranged in the machine body or the machine base, and a driving wheel arranged on an output shaft of the motor, an end of the roller brush is provided with a driven wheel rotating coaxially with the roller brush, and a transmission belt is arranged between the driving wheel and the driven wheel.

8. The floor scrubber according to claim 1, wherein the machine base is provided with a clean water pipeline allowed for spraying clean water to the roller brush, a clean water tank is arranged on the machine body or the machine base, and the clean water tank is connected to the clean water pipeline; and
a clean water pump is arranged between the clean water tank and the clean water pipeline, wherein the clean water pump is allowed for pumping clean water in the clean water tank to the clean water pipeline and spraying the clean water.

9. The floor scrubber according to claim 1, wherein a sewage tank is arranged on the machine body or the machine base, a sewage pipeline is further arranged between the sewage tank and the sewage collection chamber, and a sewage pump is arranged between the sewage tank and the sewage collection chamber, wherein the sewage pump is allowed for pumping sewage to the sewage tank.

10. The floor scrubber according to claim 1, wherein a sewage tank and a clean water tank are arranged on the machine body or the machine base, the clean water tank communicates with the roller brush through a clean water pipeline, the sewage tank communicates with the sewage collection chamber through a sewage pipeline, and a filtering device is arranged between the sewage tank and the clean water tank, wherein the filtering device is allowed for filtering the sewage.

11. The floor scrubber according to claim 1, wherein a flip cover is further arranged on the machine base and located above the roller brush, wherein the flip cover is configured for blocking the roller brush.

12. The floor scrubber according to claim 1, wherein the machine base is further provided with a dumping port for a user to dump garbage out of the garbage collection box.

13. The floor scrubber according to claim 6, wherein the driving device comprises a motor arranged in the machine body or the machine base, the motor drives and is connected to a first transmission member and a second transmission member rotatably connected to the first transmission member, and an axial direction of a rotating shaft is perpendicular to an axial direction of the second transmission member, wherein the rotating shaft rotatably connects the first transmission member to the second transmission member;
the roller brush comprises an inner cylinder and a flexible layer positioned on an outer side of the inner cylinder and fixedly connected to the inner cylinder;
the inner cylinder has a cavity allowed for being sleeved outside the first transmission member and the second transmission member, and an end of the cavity has an open port for the second transmission member to enter or exit;
when the inner cylinder is sleeved on the first transmission member and the second transmission member, the first transmission member and the second transmission member are coaxial, and a movement of the inner cylinder and the first transmission member or the second transmission member in a circumferential direction is restricted; and
when the inner cylinder is detached from or mounted on the second transmission member, the second transmission member rotates away from the machine base, and the first transmission member has a length less than a length of the second transmission member.

14. The floor scrubber according to claim 13, wherein the open port is positioned at a first end of the inner cylinder, a second end of the inner cylinder is provided with a shaft member, the shaft member is movably connected to the inner cylinder in an axial direction of the inner cylinder, an elastic member is arranged between the shaft member and the inner cylinder, and the elastic member applies a force to the shaft member to make the shaft member tend to move toward an outer end;
the shaft member is rotatably connected to a mounting base, and the machine base is provided with a hole position for arranging the mounting base; after the elastic member is compressed, the mounting base is separable from the hole position, and the roller brush is detachable; and
after the elastic member rebounds, the shaft member abuts against the mounting base to be arranged at the hole position.

15. The floor scrubber according to claim 14, wherein both the hole position and the mounting base are non-circular, and when the mounting base is arranged at the hole position, a movement of the mounting base and the hole position in a circumferential direction is restricted.

16. The floor scrubber according to claim 2, wherein the water squeezing device is a squeezing block arranged on the machine base, and when the roller brush rotates, the squeezing block is allowed for squeezing the sewage on the roller brush into the sewage collection chamber.

17. The floor scrubber according to claim 3, wherein the water squeezing device is a squeezing block arranged on the machine base, and when the roller brush rotates, the squeezing block is allowed for squeezing the sewage on the roller brush into the sewage collection chamber.

18. The floor scrubber according to claim 2, wherein the roller brush comprises an inner cylinder and a flexible layer positioned on an outer side of the inner cylinder and fixedly connected to the inner cylinder, and the flexible layer is made of a PVA or PVB material.

19. The floor scrubber according to claim 3, wherein the roller brush comprises an inner cylinder and a flexible layer positioned on an outer side of the inner cylinder and fixedly connected to the inner cylinder, and the flexible layer is made of a PVA or PVB material.

20. The floor scrubber according to claim 2, wherein a driving device is arranged in the machine body or the machine base, wherein the driving device is allowed for driving the roller brush to rotate.
